(19) United States
(12) Patent Application Publication
(10) Pub. No.: US 2014/0270909 A1
(43) Pub. Date: Sep. 18, 2014

(54) CONNECTION BETWEEN TWO ADAPTER PARTS OF A SUPPORTING APPARATUS

(71) Applicant: UNIVER S.p.A., Milano (IT)

(72) Inventor: Markus Oerder, Glashutten-Schlossborn (DE)

(73) Assignee: UNIVER S.p.A., Milano (IT)

(21) Appl. No.: 14/197,162

(22) Filed: Mar. 4, 2014

(30) Foreign Application Priority Data
Mar. 15, 2013 (EP) 13 159 375.8

(51) Int. Cl. F16C 11/10

(52) U.S. Cl. CPC F16C 11/10
USPC 403/103

(57) ABSTRACT

A connection between two adapter parts of a supporting apparatus is constructed in a modular manner for supporting tools, workpieces or the like. Each adapter part has an attachment, and a connecting clip engages behind the attachments, which are positioned facing one another, and fixes the attachments to one another in an axial and radial manner, as well as a device for fixing the attachments to one another in a non-rotatable manner. The device for fixing the attachments to one another in a non-rotatable manner has a positive locking part that is arranged between the two attachments and engages in the two attachments in a positive locking manner for the non-rotatable fixing. The connection provides a sturdy connection between two adapter parts developed in an essentially standardized manner with a small number of individual parts.

### CROSS-REFERENCE TO RELATED APPLICATION

This United States non-provisional application corresponds to and claims the benefit of foreign priority under 35 U.S.C 119(a) of European Patent Application No. 13 159 375.8, filed on Mar. 15, 2013.

### FIELD OF THE INVENTION

The invention relates to a connection between two adapter parts of a supporting apparatus constructed in a modular manner for supporting tools, workpieces or the like, wherein each of the respective adapter parts has an attachment, as well as having a connecting clip which, on sides of the attachments which face away from one another, engages behind the attachments which are positioned facing one another, and fixes the attachments to one another in an axial and radial manner, as well as having a device for fixing the attachments to one another in a non-rotatable manner.

### BACKGROUND OF THE INVENTION

Supporting apparatuses serve, in particular, for mounting on robot arms and for the attachment of tools such as clamping, gripping, sucking devices and other auxiliary means such as valves, sensors or the like. Bar parts which are connectable by means of adapters are used in this connection, the end faces of the bar parts being arranged, as a rule, at right angles with respect to the longitudinal axes of the bar parts.

A connection of the aforementioned type is known from U.S. Pat. No. 7,331,104 B2. In that connection, the non-rotatable fixing of the attachments to one another is effected as a result of the attachments, on the side thereof which faces the other one, being provided with axially extending projections which engage in the connecting clip in a positive locking manner. Accordingly, with reference to the non-rotatable connection between the two adapter parts, the force flows from one adapter part into the connecting clip and from the connecting clip into the other adapter part. Such a flow of force is disadvantageous structurally and as regards aspects of strength because the connecting clip, as a result of the realization of the force-locking reception of the connecting clip, has to be a special part and forces have to be transmitted by means of the connecting clip.

### SUMMARY OF THE INVENTION

It is an object of the present invention to create a sturdy connection between two adapter parts with adapter parts which have been developed in an extensively standardized manner, said connection having a small number of individual parts. The connection also having the adapter parts arranged at a precise angle of rotation with exact reproducibility.

This object is achieved with a connection of the aforementioned type in that the device for fixing the attachments to one another in a non-rotatable manner has a positive locking part which is arranged between the two attachments and engages in the two attachments in a positive locking manner for the non-rotatable fixing.

Accordingly, it is not necessary in the case of a connection according to the invention for the connecting clip to be shaped in a particular manner in order to contribute to the non-rotatable connection between the two adapter parts. The connecting clip can be configured as a simple standard component as it is the object of the connecting clip to fix the two attachments or the adapter parts associated therewith to one another in an axial and radial manner. The non-rotatable fixing of the attachments or adapter parts to one another is effected by means of the positive locking part which is directly effective in transmitting torque between the attachments. Consequently, torque, which is introduced by means of the one adapter part or the attachment thereof into the other adapter part or the attachment thereof, is introduced directly from the one attachment by means of the positive locking part into the other attachment.

As a result of this operating principle, it is only necessary to configure the attachments of the adapter parts such that they are able to interact in a positive locking manner with the positive locking part. Consequently, it is only necessary to configure the respective attachment in a standard manner such that it is possible for the positive locking part to engage in the attachment.

A connection according to the invention consequently makes possible a sturdy connection between the adapter parts with the prerequisite of having to keep only a small number of special parts and, furthermore, a small number of individual components. The connection can be provided in a geometrically precise manner and is reproducible exactly. The latter feature is necessary in particular in the event of damage to the supporting apparatus.

The connecting clip can be arranged in an arbitrary manner on the adapter parts or the attachments thereof, consequently at any arbitrary angle of rotation. This is particularly advantageous when constructing the supporting apparatus because regions of the supporting apparatus are frequently hard to access. In this case, the connecting clip can be closed in any arbitrary angular position. This possibility of being able to arrange the connecting clip in an arbitrary angular position is produced as a result of the fact that it is not the function of the connecting clip to transmit torque between the adapter parts, but instead to fix the attachments or the adapter parts to one another in an axial and radial manner.

According to an exemplary embodiment of the invention, it is provided that the positive locking part is realized as a disk. The disk-like shape of the positive locking part allows it to be arranged in an extremely space-saving manner and so as to transmit torque in an optimum manner between the two attachments of the adapter parts. In the simplest form, a cavity which serves to receive the disk is formed between the two attachments.

The disk may be provided radially on the outside with projections, wherein the disk engages by way of the projections thereof in recesses which are situated radially on the inside of the attachments. On the one hand, this arrangement is advantageous as regards the aspect that the disk can be configured in a particularly flat manner. On the other hand, torque between an attachment and the disk as well as the disk and the other attachment is transmitted at a relatively large spacing from the central axis of the disk.

The positive locking part, for example the disk, is preferably made of metal or plastic material. The metal is preferably aluminum or steel.

In a particularly advantageous embodiment, the disk is configured as a ring disk.

Furthermore, it is particularly advantageous when the disk has the projections uniformly distributed over the radially outer circumference. Although it is sufficient, in principle, when the projection has one projection which interacts with the respective attachment, it is advantageous as regards the aspect of the uniform introduction of torque into the disk when the disk engages in the associated attachment by means of several projections. A particularly uniform introduction of force from the attachment into the disk, or conversely, from the disk into the attachment, is produced when the projections are arranged uniformly distributed over the outer circumference of the disk.

A particularly simple shaping of the disk and of the projections thereof is produced when the respective projection is configured in the shape of a tooth.

Correspondingly, it is particularly advantageous with reference to the respective attachment when the attachment has the recesses uniformly distributed over the radially inside circumference. The respective recess is preferably shaped such that it receives a projection with a small clearance in the tangential direction. This ensures that the two adapter parts are fixed together in a clearance-free manner or in an essentially clearance-free manner. The number of recesses of the respective attachment preferably corresponds to the number of the projections of the disk which can be moved into operative connection with said attachment, or alternatively, is twice as large, or alternatively again, is three times as large. If the number of recesses of the respective attachment corresponds to the number of projections which can be moved into operative connection with said attachment, one projection engages in each recess when the adapter parts are connected together. If, for example, twelve recesses are provided in the attachment and twelve projections associated with the attachment are provided in the disk, the adapter parts can be positioned in a twelve-part graduation, consequently positioned with respect to one another at a graduation of in each case thirty degrees (30°). If, for example, twenty-four recesses are provided in the attachment and twelve projections associated with the attachment are provided in the disk, as a result of the twenty-four-part graduation, the adapter parts can be positioned with respect to one another at a selectable angle at a graduation of fifteen degrees (15°). Where there is three times the number of recesses, consequently thirty-six recesses and twelve projections, the graduation would then be ten degrees (10°).

It is considered to be particularly advantageous when the respective projection engages in recesses of both attachments. Torque is consequently transmitted from the one attachment directly via the respective projection into the other attachment.

As regards the aspect of a small number of individual components, it is deemed to be particularly advantageous when the attachments are configured in an identical manner, and more preferably, when the adapter parts are identical.

It is deemed to be particularly advantageous structurally when the respective attachment has a flat, radially arranged end face which faces the other attachment, and additionally, a radially outer circular contour as well as a circular ring-shaped clamping face which is situated on the side remote from the end face, and further, wherein the clamping face is arranged in an inclined manner with reference to a radial plane and interacts with a clamping face of the connecting clip, which is arranged in a correspondingly inclined manner. Said shaping makes it possible for the connecting clip to be placed in position simply and the two attachments to be securely clamped against one another, with the attachments or adapter parts being fixed to one another radially at the same time. In a particularly favorable manner, a clamping force can be applied onto the two attachments by means of the connecting clip via the clamping faces, which are arranged in an inclined manner with reference to the radial plane.

The connecting clip is preferably shaped in such a manner that it has two legs connected to one another in a flexible manner. The connecting clip, in the region of the ends of the legs remote from the pivot joint, has means for connecting the two legs when the legs are in the closed position. The means for connecting have, in particular, a screw that is pivotably mounted in the one leg and an attachment that is mounted in the other leg. When the ends of the legs remote from the pivot joint are moved toward one another, the screw is pivoted behind the attachment by way of the screw head and the screw is then screwed in, as a result of which the connecting clip surrounds the attachments of the two adapter parts in a clamping manner.

If desired, the adapter parts of the supporting apparatus constructed in a modular manner can be configured differently. It is deemed to be advantageous when at least one of the adapter parts, in particular both adapter parts, has a hollow profile portion for the displaceable, axially fixable and in particular non-rotatably fixable reception of a bar part of the supporting apparatus. Tools, workpieces or the like can then be fastened on the bar part, for example by means of further adapter parts.

### BRIEF DESCRIPTION OF THE DRAWING FIGURES

Further objects, advantages and features of the invention are disclosed in the forthcoming detailed description of exemplary embodiments of the invention, the brief description of the drawing figures, as well as the figures themselves, it being remarked that the intended scope of the invention is limited only by the appended claims.

The invention is described in greater detail hereinafter and shown in the accompanying drawing figures by way of two exemplary embodiments, without being restricted to the same.

FIG. 1 is an exploded perspective view of a first exemplary embodiment of a connection according to the invention shown prior to producing the connection between two adapter parts.

FIG. 2 is a sectional view of the connection produced between the two adapter parts according to the exemplary embodiment of FIG. 1.

FIG. 3 is a perspective view of a second exemplary embodiment of a connection according to the invention shown prior to producing the connection between two adapter parts.

### DESCRIPTION OF EXEMPLARY EMBODIMENTS OF THE INVENTION

FIGS. 1 and 2, relating to a first exemplary embodiment of a connection according to the invention, show a supporting apparatus constructed in a modular manner in the region of two adapter parts 1 and 2 to be connected. In this connection, the adapter part 1 has two half shells 3 and 4 connectable by means of two screws 5. The respective screw 5 is pushed through a bore 6 of the half shell 3 and screwed into a threaded bore 7 of the half shell 4. The respective screw 5 may be a hexagon socket-head screw.

The half shell 3, on its side facing the half shell 4, has a recess 8 with a semi-circular cross section. The half shell 4, on its side facing the half shell 3, has a recess 9 which is defined on its side remote from the recess 8 by angled wall portions 10 of the half shell 4. As a result of the shaping of the recesses 8 and 9, they serve to receive a bar portion 11 of the supporting apparatus having an outside cross section which deviates from a circular outside cross section in such a manner that the bar portion abuts against the wall portions 10 and consequently is certainly received by the recesses 8 and 9 but, as a result of the configuration of the wall portions 10, is mounted in a non-rotatable manner by means of the half shells 3 and 4. When the screws 5 are tightened, the half shell 3 clamps the bar portion against the half shell 4.

The other adapter part 2 is connected to such a bar portion 11. The connection is effected by means of a screw 12 which penetrates a bore 13 in the adapter part 2 and is screwed into a threaded portion 14 of a threaded bushing 15, which in turn is screwed into a bore 16 of the bar portion 11 in a cutting manner. Additional non-rotatable fixing of the adapter part 2 and the bar portion 11 is effected by means of positive locking elements 42, which are connected to the adapter part 2 in the region of the separating face between the adapter part 2 and the bar portion 11 and engage in recesses 43 of the bar portion 11.

The adapter part 1 has an attachment 17 and the adapter part 2 has an attachment 18. The respective attachment 17 or 18 has a flat, radially arranged end face 19 which faces the other attachment, in addition to a radially outside circular contour 20 as well as a circular ring-shaped clamping face 21 which is situated on the side remote from the end face 19. The clamping face 21 is arranged in an inclined manner with reference to a radial plane which coincides with the end face 19. The respective attachment 17 or 18 tapers radially outward. The attachments 17 and 18 are configured in a symmetrical manner with reference to the respective end face 19 and, consequently, have in particular the same outside diameter, as is predetermined by the contour 20. The inclination of the respective clamping face 21 is also identical with reference to contour 20 or end face 19. Consequently, as can be seen in the representation of FIG. 2 in particular, a mirror-symmetrical arrangement of the respective end faces 19, the respective contours 20 and the respective clamping faces 21 is produced.

The attachment 17 has an inwardly curved bottom 22 and the attachment 18 has a cylindrical recess 23 for the head of the screw 12. In addition, the attachments 17 and 18 have identical setoffs on their facing sides. The respective one setoff 24 extends along a full circle and serves to receive a device for fixing the attachments 17 and 18 to one another in a non-rotatable manner, this being a positive locking part which is configured as a disk 25. Disk 25 as shown herein is shaped as a ring disk of aluminum which has a ring-shaped projection 26 on each axially remote side, the attachment 17 being supported in the region of the setoff 24 thereof on the projection 26 of the disk 25 and the attachment 18 being supported in the region of the setoff 24 thereof on the projection 26 of the disk 25. In this connection, a small gap is formed between the end faces 19 of the attachments 17 and 18.

In the region between the two projections 26, the disk 25 has a portion 27 with tooth-shaped projections 28 that are arranged uniformly distributed on the radially outer circumference. The disk 25 is consequently configured as a type of quasi gear wheel. Twelve teeth are provided in the case of this exemplary embodiment, consequently at a circular graduation of thirty degrees (30°).

The respective attachment 17 or 18 is provided in the region of the end face 19 with recesses 29 that are open radially inwards. Definitively, there are twenty-four recesses 29 provided that are distributed uniformly over a full circle, consequently at a circular graduation of fifteen degrees (15°). Each respective recess 29 is shaped in such a manner that a projection 28 of the disk 25, which is inserted into the recess 29 in the axial direction of the disk 25 with a small amount of clearance in the circumferential direction, consequently, in an imaginary rotational direction of the disk 25, engages in the recess 29 by way of the projection 28. With the disk 25 positioned between the attachments 17 and 18, the same consequently engages in the associated two recesses 29 of the attachments 17 and 18 by way of the respective projection 28, as a result of which a non-rotatable connection is produced between the two attachments 17 and 18, and consequently, the adapter parts 1 and 2 by means of the disk 25.

The graduation of the disk 25 with the projections 26 thereof with reference to the graduation of the respective attachment 17 or 18 with the recesses 29 thereof makes it possible to position the adapter parts 1 and 2 rotated with respect to one another in steps of fifteen degrees (15°).

A connecting clip 30 is provided for fixing the attachments 17 and 18 to one another or the adapter parts 1 and 2 to one another in an axial and radial manner. The connecting clip has two legs 31 and 32. The two legs 31 and 32 are connected together by means of a pivot joint 33. In the region of the end thereof remote from the pivot joint 33, the leg 31 has a U-shaped bearing attachment 34. In the region of the end thereof remote from the pivot joint 33, the other leg 32 receives in a pivotable manner a bearing bolt 35, which is arranged parallel to the pivot joint 33 and in which a threaded bore (not shown) is inserted, into which threaded bore a screw 36, which as shown herein is a hexagon socket-head screw, is screwed. With the connecting clip 30 situated in the closed position, when the legs 31 and 32 are pivoted toward one another, the screw 36 is pivoted into the U-shaped bearing attachment 34 and the head 37 of the screw 36 engages there behind the leg 31. By screwing in the screw 36, the legs 31 and 32 of the connecting clip 30 are moved further toward one another and thus serve to connect the attachments 17 and 18 and, consequently, to connect the adapter parts 1 and 2.

Consequently, to produce the connection between the two adapter parts 1 and 2 with the adapter parts disassembled, the disk 25 is, for example, first inserted into the recesses 29 of the attachment 17 and then the attachments 17 and 18 are moved toward one another such that the disk 25 also engages in the recesses 29 of the attachment 18. Care must be taken in this respect to ensure that the adapter parts 1 and 2 assume the correct position of the angle of rotation with respect to one another. When the aforesaid intermediate assembly step has been reached, the attachments 17 and 18 abut against the disk 25 in the region of the projections 26, and the attachments 17 and 18 are situated at a small spacing from one another in the region of the end faces 19 thereof. The open connecting clip 30 is then placed in the region of the attachments 17 and 18 onto said attachments and the legs 31 and 32 are pivoted toward one another, contact faces 38 of the leg 31 and of the leg 32, which are inclined corresponding to the clamping faces 21 of the attachments 17 and 18, abutting against the clamping faces 21. When the connecting clip 30 is closed and the screw tensioned, the connecting clip 30 is closed in an increasing manner, as a result of which the effective diameter of the connecting clip 30 is slightly reduced and therefore pressure is exerted onto the clamping faces 21 via the contact faces 38, with the result that the attachments 17 and 18 are clamped axially against one another and in addition are fixed in a radial manner.

Consequently, an axial and radial connection between the adapter parts 1 and 2 is effected by means of the connecting clip 30 and a non-rotatable connection is brought about by the interaction between the attachments 17 and 18 and the disk 25.

The second exemplary embodiment of the connection according to the invention shown in FIG. 3 differs from that according to FIGS. 1 and 2 only in that in the case of the adapter part 2 the attachment 18 is not connected to a bar portion 11, and further, the adapter part 2 is formed corresponding to the adapter part 1. Consequently, corresponding to the half shells 3 and 4, adapter part 2 has half shells 39 and 40, which are connectable by means of two screws 41 that correspond to the screws 5. The half shell 40 forms a component with the attachment 18 according to the exemplary embodiment shown in FIGS. 1 and 2.

In the case of the exemplary embodiment according to FIG. 3, the adapter part 2, just as the adapter part 1, consequently serves to receive a bar portion 11.

1-15. (canceled)

16. A connection between two adapter parts of a supporting apparatus comprising:
a first adapter part having a first attachment;
a second adapter part having a second attachment positioned to face the first attachment of the first adapter part;
a connecting clip configured to engage the first attachment and the second attachment on sides that face away from one another and fix the first attachment and the second attachment to one another in an axial and radial manner; and
a device for fixing the first attachment and the second attachment to one another against rotation, the device having a positive locking part disposed between the first attachment and the second attachment that engages in the first attachment and the second attachment in a positive locking manner to fix the first attachment and the second attachment to one another against rotation.

17. A connection according to claim 16, wherein the positive locking part is configured as a disk.

18. A connection according to claim 17, wherein the disk is provided radially on the outside with projections, and wherein the disk engages by way of the projections in recesses situated radially on the inside of the first attachment and the second attachment.

19. A connection according to claim 18, wherein the disk has the projections uniformly distributed over the radially outer circumference of the disk.

20. A connection according to claim 18, wherein the projections are configured in the shape of a tooth.

21. A connection according to claim 19, wherein the recesses are uniformly distributed over the radially inner circumference of the first attachment and the second attachment.

22. A connection according to claim 18, wherein the recesses are shaped to receive the respective projections without play in the tangential direction.

23. A connection according to claim 18, wherein the number of recesses of each of the first attachment and the second attachment corresponds to the number of the projections of the disk that engage into operative connection with the first attachment and the second attachment.

24. A connection according to claim 18, wherein the number of recesses of each of the first attachment and the second attachment is two times the number of the projections of the disk that engage into operative connection with the first attachment and the second attachment.

25. A connection according to claim 18, wherein the number of recesses of each of the first attachment and the second attachment is three times the number of the projections of the disk that engage into operative connection with the first attachment and the second attachment.

26. A connection according to claim 18, wherein each of the projections engages in the recesses of both the first attachment and the second attachment.

27. A connection according to claim 16, wherein the positive locking part is made of a metal material.

28. A connection according to claim 16, wherein the positive locking part is made of a plastic material.

29. A connection according to claim 16, wherein the first attachment and the second attachment are configured in an identical manner.

30. A connection according to claim 16, wherein each of the first attachment and the second attachment has a flat, radially arranged end face that faces the other attachment, a radially outer circular contour, and a circular ring-shaped clamping face situated on the side remote from the end face, and wherein the clamping face is arranged in an inclined manner with reference to a radial plane and interacts with a clamping face of the connecting clip arranged in a correspondingly inclined manner.

31. A connection according to claim 16, wherein the connecting clip has two legs that are connected to one another in a flexible manner, and wherein the connecting clip has means for connecting the two legs in the region of the end of the legs remote from a pivot joint when the legs are in a closed position.

32. A connection according to claim 31, wherein the means for connecting comprises a screw pivotably mounted in one leg and an attachment mounted in the other leg, and wherein a screw head engages behind the attachment when the connecting clip is closed.

33. A connection according to claim 16, wherein the first adapter part and the second adapter part are supported axially by means of the disk.

34. A connection according to claim 16, wherein the first attachment and the second attachment are supported axially by means of the disk.
